(19) United States
(12) Patent Application Publication
(10) Pub. No.: US 2015/0292693 A1
(43) Pub. Date: Oct. 15, 2015

(54) Illuminating Vessel Sink Ring

(71) Applicant: Craig Robert Franke, Indianapolis, IN (US)

(72) Inventor: Craig Robert Franke, Indianapolis, IN (US)

(21) Appl. No.: 14/250,334

(22) Filed: Apr. 10, 2014

(51) Int. Cl. F21S 4/00; E03C 1/182; F21V 33/00

(52) U.S. Cl. CPC F21S 4/006; F21V 33/004; E03C 1/182

(57) ABSTRACT

A dual purpose illuminating device providing base support for bowls, vessel basin sinks, or the like for use in the plumbing industries. The apparatus consisting of metal circular alloy containing an interior and exterior housing metrics with advanced electronic circuits and energy efficient “chip style” light emitting diodes, commonly referred to as SMD's Surface Mount Diodes. The light source situated as such to make up the outer and inter sidewalls of the ring structure providing a conspicuous amount of illumination both interior and exterior to the vessel sink and surroundings. The multi-colored & static-color lighting effects provide a delightfully & bedazzling display while providing a utilitarian base mounting ring for vessel sink bowls.

### REFERENCES CITED

U.S. Pat. Documents

| | | | |
|---|---|---|---|
| 2,330,592 | September | 1943 | Kendrick |
| 3,719,821 | March | 1973 | Foreman |
| 5,586,691 | December | 1996 | Gotch et al |
| 5,491,617 | February | 1996 | Currie |
| 4,777,570 | October | 1988 | Littles |
| 6,729,740 | May | 2004 | Gazard |
| 12271757 | May | 2010 | Winters |

### A. CROSS-REFERENCE TO RELATED APPLICATIONS

Not Applicable.

### B. FEDERALLY SPONSORED RESEARCH

Not Applicable.

### FIELD OF INVENTION

The foregoing disclosure is applicable to a dual purpose illuminating plumbing devise utilizing to a higher degree both, but not limited to, esthetic and utilitarian functionality while providing unique lighting effects for vessel basin sink and counter tops.

### BACKGROUND OF INVENTION

The following dictates background information as it relates to the aforementioned disclosure.

Vessel support rings characteristically known as rings, mounting rings compression rings, flange, metal/plastic washers or the like, are devises that generally serve as the medium insert nestled between the vessel sink and the basin counter top. Commonly, these devise are unimaginative ring shaped structures and typically found with various sold surface treatments to include polished chrome, stainless steel, brushed aluminum, bronze and so on.

Up until now there has been no hi-tech energy efficient solution in pairing ambient light mechanisms with vessel ring supports. However, the illumination of counter tops, vessel, vessel sinks and plumbing fixtures in bath environments has taken several forms in prior art. For instants, U.S. Pat. No. 5,586,691 (Gotch et al.; 1996), discloses a combination dispense tap and

customer information display wherein a tap handle is made of light-transparent material that is illuminated by light that is transmitted from a hidden light source, which is attached on the outside of the tap body. In an alternative embodiment a remote spotlight shines on a reflective handle. Thus the control is illuminated, but not the associated spout nor vessel ring, and the light source is attached outside of the spout and control.

U.S. Pat. No. 5,491,617 (Currie; 1996) discloses an illuminated fluid tap wherein fiber optic cables (20, 30) transmit light from a hidden remote source into a transparent/translucent plastic tap handle (50) and to an area beyond the tap outlet (spout) for illuminating the stream of fluid. Again the control is illuminated, but not the associated spout or a vessel ring,

U.S. Pat. No. 2,330,592 (Kendrick; 1941) discloses a nozzle illuminating means wherein a light source is attached to a handle (control) and directs light through a light pipe to the end of a nozzle for lighting the area ahead of the nozzle. Neither the spout nor control are illuminated, and the light source is attached on an outer portion of the device.

U.S. Pat. No. 6,729,740 (Gazard; 2004) discloses a door knob night light wherein a translucent or transparent door knob contains its own light source. Similarly, U.S. Pat. No. 4,777,570 (Littles; 1988) discloses an illuminated door knob lock wherein the light source is contained in the door knob, and U.S. Pat. No. 3,719,821 (Foreman; 1973) discloses an illuminated attachment for a lock-equipped door knob as a means of providing room lighting effects.

U.S. patent Ser. No. 12/271,757 (Winters; 2010) discloses an illuminating vessel ring wherein the light source is contained within the ring structure for the purposes of emitting light upon the vessel, cup or other fixture. However, said ring is not specifically designed to be used in conjunction with a vessel sink bowl. Further, The LED light source differs. Winter's design employs the use of cone shape LED's, older and inefficient technologies. The present invention utilizes SMT—Surface Mount Technology, “chip style LED's which are more energy efficient, brighter light source, longer life.

None of the above prior art devices appear to provide much in the way of teaching about illumination or the projection of light from within or upon the outside surface of a vessel sink, ring or counter top itself.

It is an object of the present invention to provide the apparatus and alternative method for illuminating plumbing fixtures, e.g., vessel rings that are affixed below the vessel bowl, but above the basin counter top, in a way that overcomes the limitations and defects of the prior art. In particular, it is an object to illuminate a vessel sink bowl associated counter top and surroundings by using one or more exposed light source(s). It is an object to illuminate plumbing fixtures with light that is transmitted directly through a special designed opening of the vessel ring and via a reflective light source attached to the fixture for illumination. It is an object and design of the present invention to illuminate the entire vessel ring, vessel, counter top and the room environment in which the fixtures are situated. In particularly using a highly energy efficient light source, commonly referred to as chip style light emitting diode.

The inventor herein named adds a new design to this rather mundane topic of vessel sink rings by invigorating the subject with the latest showing of hi-tech electronics artfully incorporated within a vessel ring, and summarized as follows;

### BRIEF SUMMARY OF THE INVENTION

The brevity of this summary disclosure is not intended to include every element or feature within the scope of the invention, nor intended to be exhaustive or comprehensive by its nature or description.

According to the invention, an illuminating vessel sink ring, a dual purpose device, providing both illumination and base support for translucent or opaque vessel basin sinks.

According to the invention, The illuminating vessel sink ring consisting of a metal circular alloy containing an interior and exterior light emitting sidewalls with advanced electronic circuits and energy efficient “chip style” light emitting diodes. The light source situated as to make up the outer and inter sidewalls of the ring structure providing conspicuous amounts of illumination both internally and externally to the vessel sink and surrounding area. The light source emitting multicolored illuminations and lighting effect which include, but not limited to, constant single color, fadeout from color to color, strobe, flash, and jump from color to color, with variable speed and duration.

Additionally, a lighting method from a constrained area through an opening in the ring is disclosed. The method of illumination may include a hollow ring in the dispersant of light in a circular fashion through an opening, allowing viewing of the illumination within the constrained area through an access passage defined by the hollow member.

Another feature of the present invention is a lighting method from a constrained area from the leading edge of an object, namely a vessel ring is disclosed. The method may include a solid or semi solid structure by which the independent light source is attached by adhesive or by other know means.

In addition, the present invention provides solutions to the shortcomings of conventional apparatuses and methods of illuminating an object from a constrained area. Those of ordinary skill in the art will appreciate, however, that these and other details, features and advantages will become further apparent as the following detailed description proceeds.

### BRIEF DESCRIPTION OF DRAWINGS

The drawings described herein are for illustrative purposes only of selected embodiments and not showing all possible implementations, and are not intended to limit the scope of the present disclosure.

FIG. 1 is a black & white photo realistic sketch of the Light Emitting Diode LED strip light, as shown to be flexible & commonly referred to a SMD's

FIG. 2 is a black & white photo realistic sketch of a interior metal housing component of the intention depicting the grooved surface.

FIG. 3 is a black & white photo realistic sketch depicting the LED light strip inserted within the metal housing component.

FIG. 4 is a black & white photo realistic sketch visualizing the manner in which components are sandwiched together to form the invention.

FIG. 5 is a black & white photo realistic sketch illustrating a cross sectional view of interior and exterior lighting components of the present invention.

FIG. 6 is a black & white photo realistic sketch in combination with a traditional mechanical drawing depicting a typical installation diagram wherein the wiring is hidden underneath the basin surface of the invention.

FIG. 7 is a black and white photo realistic sketch in combination with a traditional mechanical drawing depicting a secondary installation diagram wherein the wiring of the invention is exposed on the surface of the basin counter top support.

FIG. 8 is a black & white photo realistic sketch illustrating a view of the invention as it would rest between and vessel sink and basin counter top.

FIG. 9 is a black & white photo realistic sketch illustrating an alternative assemble of two components of the invention, while FIG. 9A a third component of the same illustrates the relative position of the LED light strip.

FIG. 10 is a black & white photo realistic sketch illustrating various external components of the invention, Power supply, remote, control unit, switch.

FIG. 11 is a black & white photo quality image of the invention from a forward side view.

### DETAILED DESCRIPTION OF PREFERRED EMBODIMENTS

The following describes embodiments of the invention and are provided to more fully convey the scope to those who are skilled in the art. Numerous specific details are set forth such as examples of specific components, devices, and methods, to provide a thorough understanding of embodiments of the present disclosure. It will be apparent to those skilled in the art that specific details need not be shown, that the embodiments may be available in many different forms and that neither should be construed to limit the scope of the disclosure. In some example embodiments, well-known processes, well-known device structures, and well-known technologies are not described in detail.

In various implementations the disclosure is directed to an illuminating vessel sink ring as a support device for vessel sink bowls. Various lighting effects can be achieved dependent on the device and vessel configurations. It should be understood that the term “vessel” is used in the present disclosure and claims to refer to any of a wide variety of vessel shapes and sizes, including but not limited to round bowl, oblong, square, rectangular etc. While vessels can vary in shape, size, and coloration, they may also be partially or completely transparent, translucent, opaque, or any combination of the foregoing. Vessels may be partially or completely sealed, covered and/or open when supported by the illuminating vessel ring in accordance with the disclosure.

Now referencing a detailed description of the drawings by numbered characters designating the corresponding parts throughout the several views.

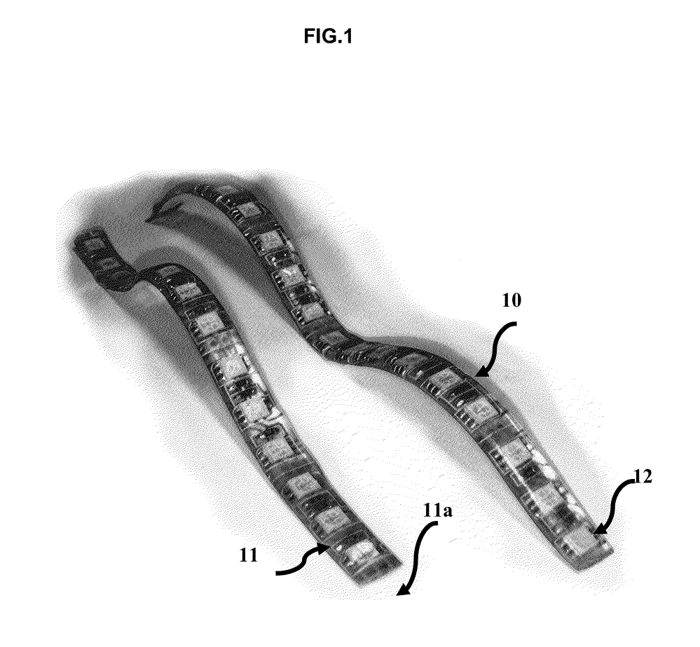

FIG. 1 of the photo sketches illustrates the primary embodiment of the present invention, the chip style, LED light emitting diodes light strips 10 & 11. The chip style, LED pointed out at 12 come in various dimensions, while the LED's mounted on the PCB, printed circuit board are flexible water proof with different lengths and widths. One of the primary characteristic of the chip style LED that's set them apart from other man made LED's is a technology commonly know as SMT, Surface Mount Technology. SMT is an automated robotic method of assemble and essential element required in order to perfect the present invention.

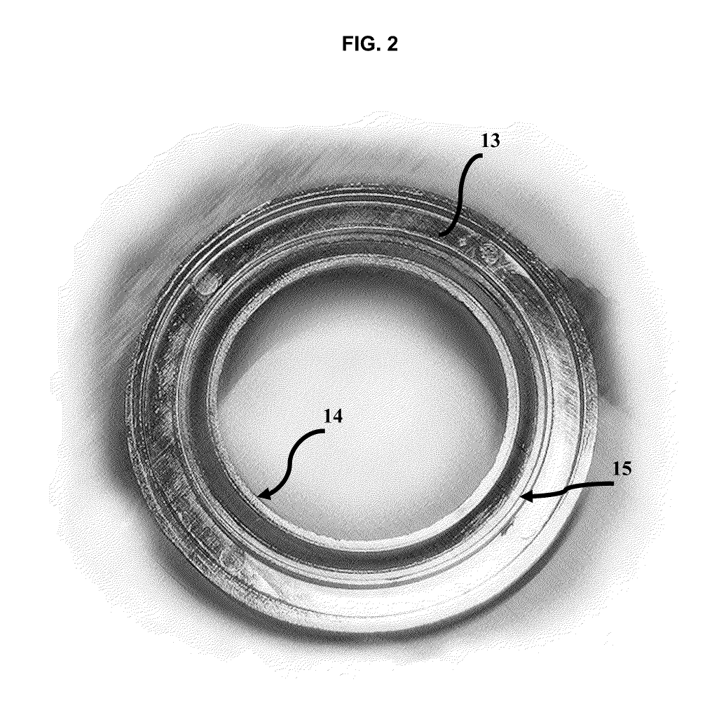

FIG. 2 illustrates a component of the Self-illuminating Vessel Ring. The pictured component makes up a strategic part of the invention as it serves as a coupler housing 13 and protecting the LED strip lights. One particular characteristically of the coupler is its grooved inter surface area at 14 & 15 perceptively. The two narrowly grooved surface areas provides an inter-locking and retaining platform from which the light strips are uniformly inserted and held in place.

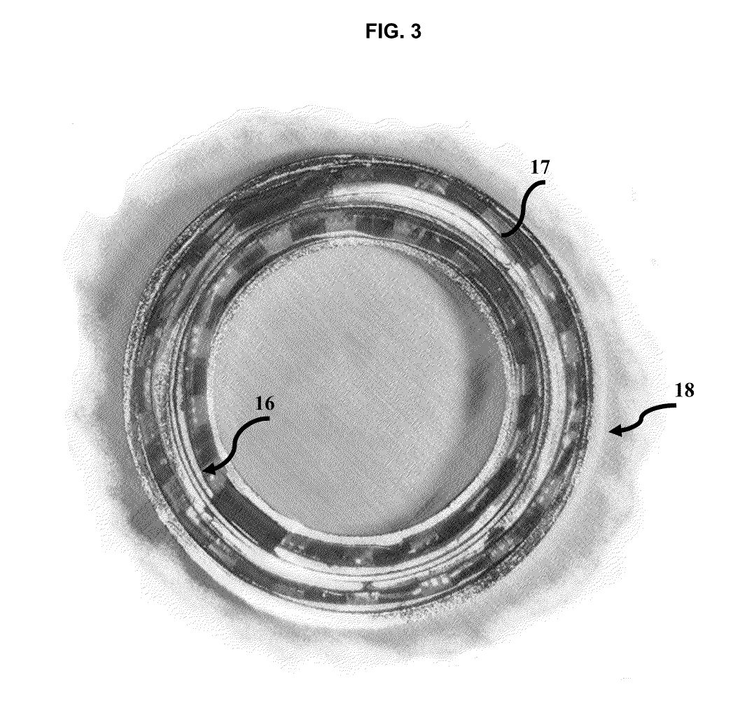

FIG. 3 provides a more visually detailed view of the light strips as shown inserted into the coupler at 18. The light strips identified at 16 & 17 are configured in a circumferential position within the coupler. The light strip at 16 is wrapped within the coupler so that the LED's are facing inward towards the circular center opening of the coupler. The light strip at 17 is wrapped outward towards the outside leading edge of the coupler. The LED's are thus facing outward towards the same outside leading edge of the coupler.

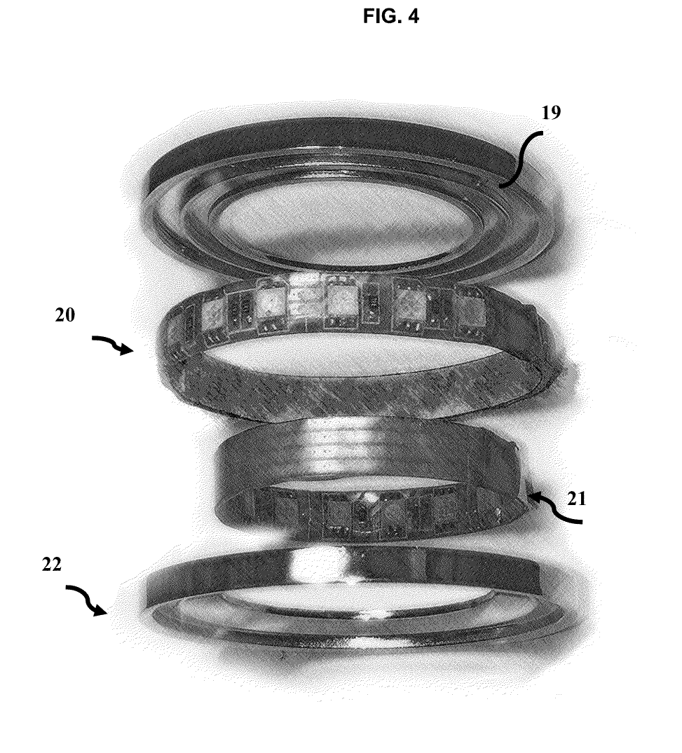

FIG. 4 provides a cross sectional elevation view of the couplers at 19 & 22 which makes up primarily the most ridge components of the self-illuminating vessel ring. The circumference of the inter LED strip is generally smaller than the circumference of the outer LED strip. The LED's are essential sandwiched in-between the two couplers. The couplers providing base support for a vessel basin sink.

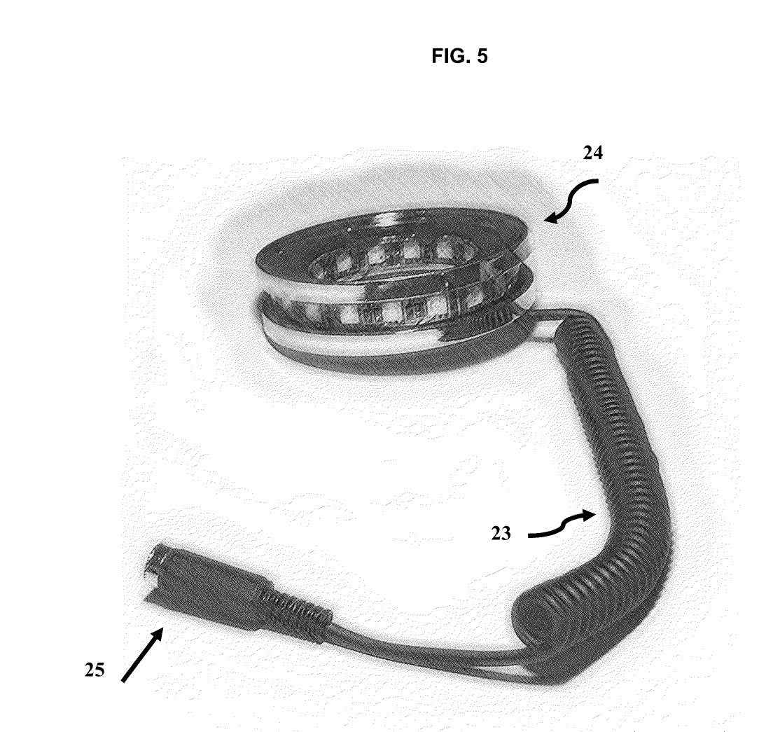

FIG. 5 provides a cross aerial view of the self-illuminating vessel ring at 24. 23 illustrates the an ac/dc power cord, and plug type at 25 necessary in provide the electrical conduit to illuminate the LED strip.

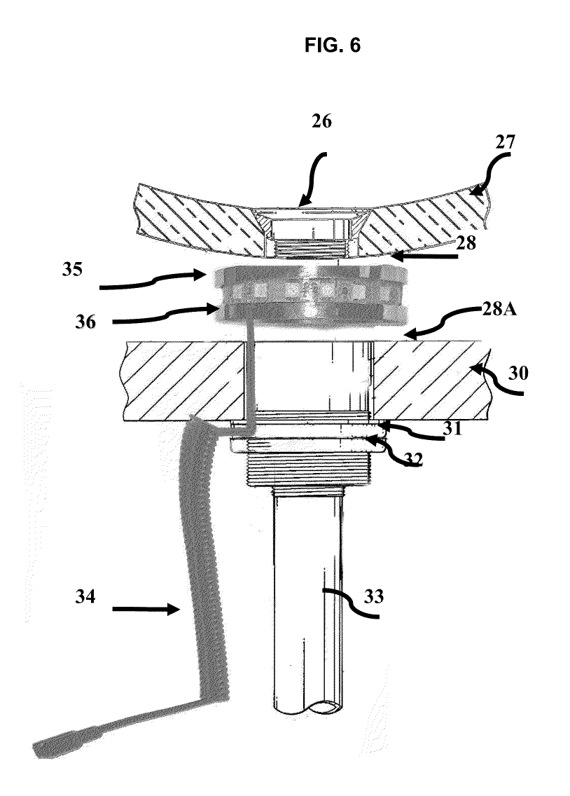

FIG. 6 further illustrates a typical mounting scenario with emphases on the characteristic location of the power supply wire at 34 as it is situated below the opening of the counter top shown at 30. The common drain plug pipe at 26 is inserted down through the center of the upper and lower couplers at 36. The vessel sink at 27 rests securely on rubber o-ring at 28A, while the lower coupler rest upon a rubber o-ring at 28 between the counter top. A rubber washer at 31 is gaped as to allow the power cord to feed through resting below the upper surface of the rubber washer. This method allows for the nut 32 to securely apply a 360 degree contact around the gaped rubber washer less the gap incision. This method is critical to insure the vessel sink is snuggled tightly against the o-ring and coupler to prevent water leaks that spills from the vessel sink.

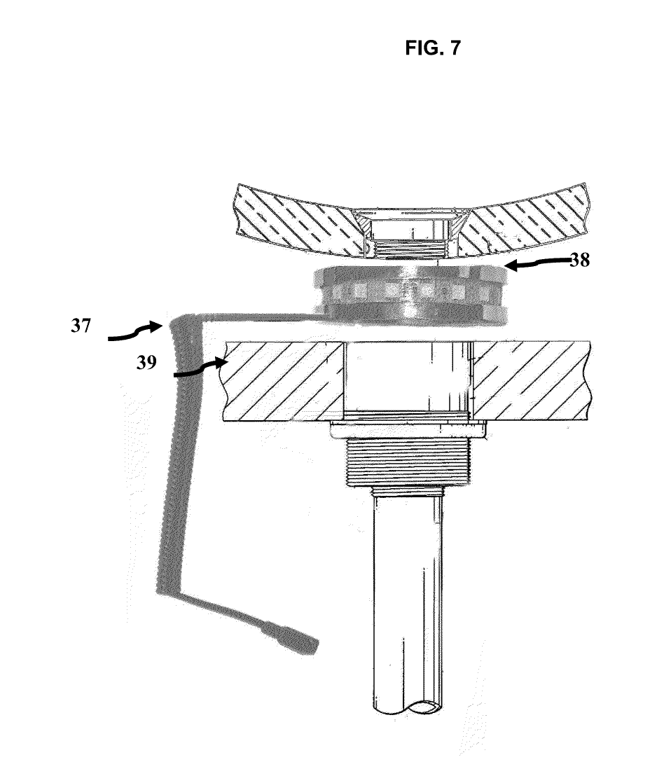

FIG. 7 A secondary mounting scenario as it differs from FIG. 7 is shown with emphases on the characteristic location of the power supply wire location. In this instants. The vessel ring 38 sits on the top surface of the counter top 39 as opposed to feeding the power wire 37 through the opening in the counter top.

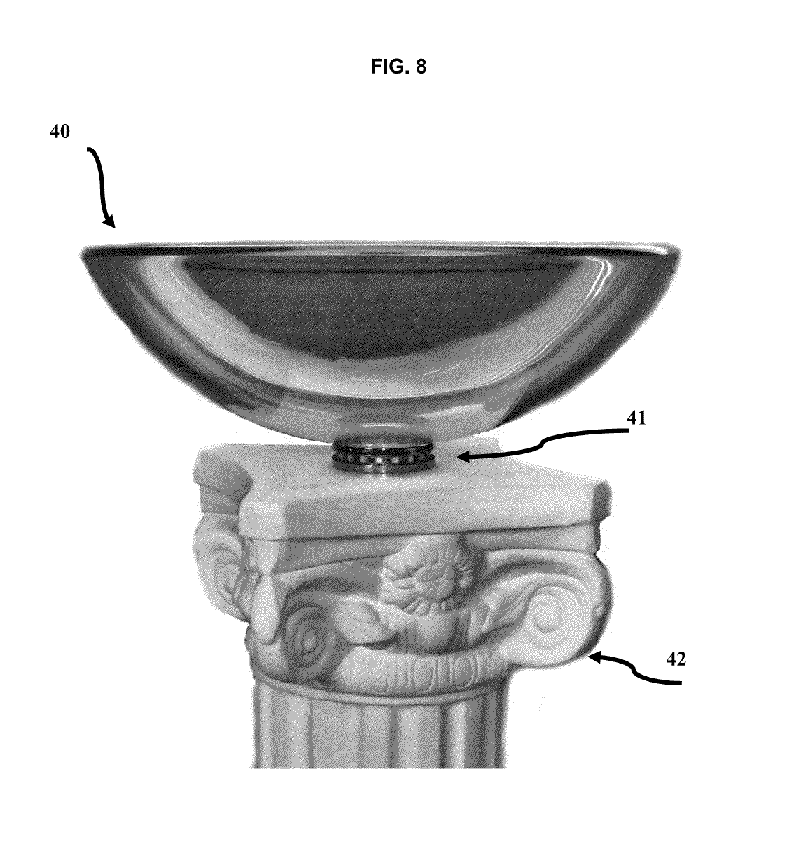

FIG. 8 illustrates how the vessel ring 41 would appear in a real-life application wherein the vessel sink 40 is mounted atop of the vessel ring upon a pedal style basin counter top 42 with the power wire hidden as described in FIG. 6.

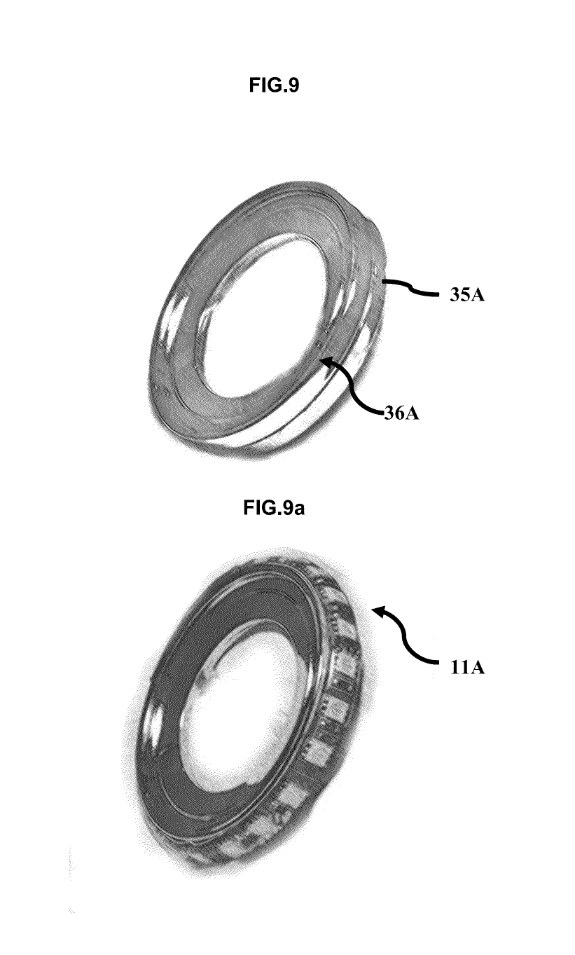

FIG. 9 plainly reveals the same components herein described, namely the couplers 35A & 36A and the LED light strip 11A. This particular illustration demonstrates an assembly variation much like the mounting variation described in FIGS. 6 & 7 In this instants, the couplers are joined together to form a single coupler. The same LED light strip is then adhered to the outside leading edge of the coupler.

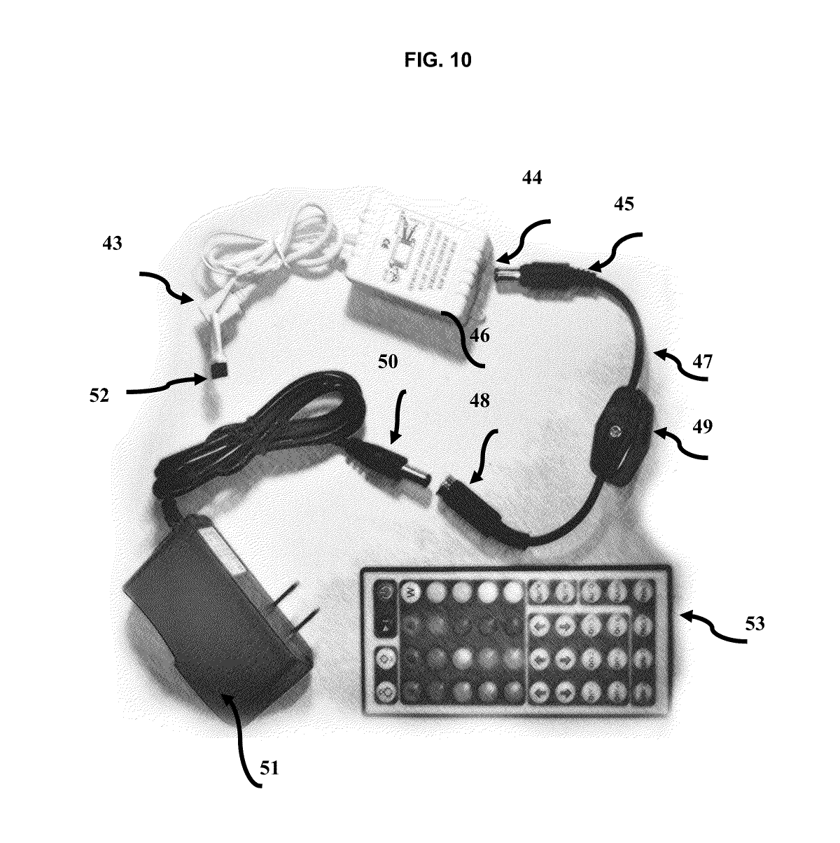

FIG. 10 provides by example some of the various external components of the self-illuminating vessel ring. 51 is shown as the 12 volt ac/dc power supply as 50 plugs into 48 of the manual power on/off switch controlled by the thumb wheel at 49. In additional adapter not pictured would allow a battery power supply as opposed to a direct ac/dc power source. The male wire side of the switch 47 includes a male plug at 45 which attached to the strip light control unit 46 at 44. The control unit consists of two separate wires. 43 may attach directly to the LED light strip at 11A. In additional, an adapter not picture will also allow the power cord of the vessel ring to connect directly to the adapter end of 43. The controller includes an IR infrared receiver at 52 that responds to commands from the remote control at 53. The 48 key remote control allows the user to program various lighting sequences of color variations within the known mixed color spectrum of red, green & blue. The mixing of colors via the remote allows for the appearance of secondary colors to appear such as yellows, purples, & fuchsia, others. Apart from the color programming feature, the remote allows for a dancing color display of lights, which includes, but not limited to a multicolor strobe light effect, fade/in, fade/out of colors, jumping from color to color at users preference.

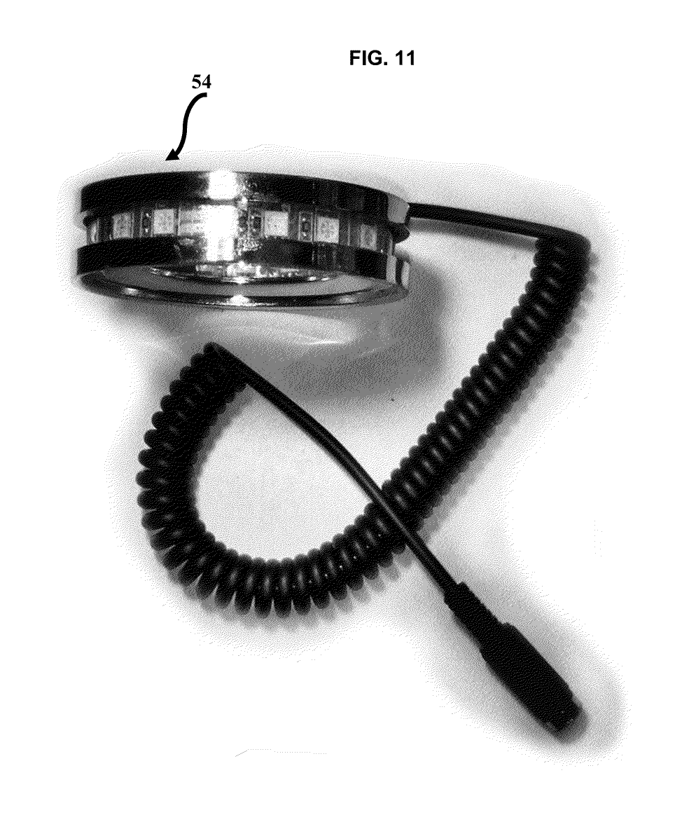

FIG. 11 The last of the illustrative views provides a black & white high quality close-up image of the self-illuminating vessel ring as referenced by 54 and demonstrative of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth herein above will occur to one having ordinary skill in the art to which the present invention most nearly pertains, and such variations are intended to be within the scope of the invention, as disclosed herein.

What is claimed is:

1. In an illuminating vessel sink bowl ring, the combination of a plurality of waterproof surface mount diode affixed to a flex strip substrate situated on a linear axes, interconnecting a lower and upper circular flange support

2. The combination defined in claim 1, wherein the surface mount diodes are positioned within the circular flange support as to emit light outward from the flex strip substrate with a 360* visibility radius.

3. The combination defined in claim 2, wherein the surface mount diodes are positioned within the circular flange support as to emit light inward from the flex strip substrate to the interior circumference of the circular flange.
